(19) United States
(12) Patent Application Publication
(10) Pub. No.: US 2012/0181398 A1
(43) Pub. Date: Jul. 19, 2012

(54) Portable Section Remote Camera Tower

(76) Inventor: Charles S. SALVATO, Daytona Beach, FL (US)

(21) Appl. No.: 13/351,224

(22) Filed: Jan. 16, 2012

Related U.S. Application Data
(60) Provisional application No. 61/433,033, filed on Jan. 14, 2011.

(51) Int. Cl. F16M 11/00; F16M 11/26; F16M 11/24; F16M 11/18

(52) U.S. Cl. 248/122.1

(57) ABSTRACT

A portable section remote camera tower is an apparatus that used to elevate a camera off the ground. The apparatus is constructed from thin structural pipes, which makes the apparatus relatively inexpensive and relatively easy to assemble. The apparatus comprises a center support, a plurality of ground plates, a plurality of turnbuckles, and a camera adjustment system. The center support is a vertical structural member that is the main support for the camera from the bottom. The plurality of turnbuckles pulls the top of the center support from all directions towards the ground to keep the center support plumb. The center support and the plurality of turnbuckles are anchored to the ground by the plurality of ground plates. The camera adjustment system is used to tilt and pan the camera.

The current application claims a priority to the U.S. Provisional Patent application Ser. No. 61/433,033 filed on Jan. 14, 2011.

### FIELD OF THE INVENTION

The present invention generally relates to an apparatus for elevating camera equipment or any other kind of equipment. More particularly, the present invention is a collapsible, portable equipment tower, which support and raises the equipment to height that are otherwise unreachable to a user standing or sitting upright.

### BACKGROUND OF THE INVENTION

The various television networks, particularly sports networks, currently require a person to man a tower for capturing the desired play or scene. For example, ShotLink is the PGA Tour's data gathering information system and is responsible for providing users any necessary real-time information to TOURCast. The platform used by ShotLink to capture the scene typically stands 8 feet tall guided with cables wrapped in green cloth featuring a special stairway. Many times elderly volunteers operate the camera known as ShotLink. They must climb a tower, sit in a chair, and view the golf ball drop. Then, they position the camera to view the golf ball and push a button for results, which is then aired by the sports network. Therefore, an objective of the present invention is to introduce a tower that eliminates the need for an elderly volunteer to climb in order to operate supported equipment. The present invention is an adaptable tower, which allows a user to control and support cameras or equipment with antennae at a safe distance.

Aside from the economical advantage, there are times where directors find the platform in camera shots and platforms cannot be moved. Therefore, another objective of the present invention is to resolve this problem by being constructed of thin poles. The present invention does not need to be wrapped in a green cloth and can be assembled in one-tenth the time. The present invention also is much easier to ship than an 8×8-foot tower to an island like Hawaii or the Caribbean Islands.

### BRIEF DESCRIPTION OF THE DRAWINGS

FIG. 1 is a perspective view of the present invention.

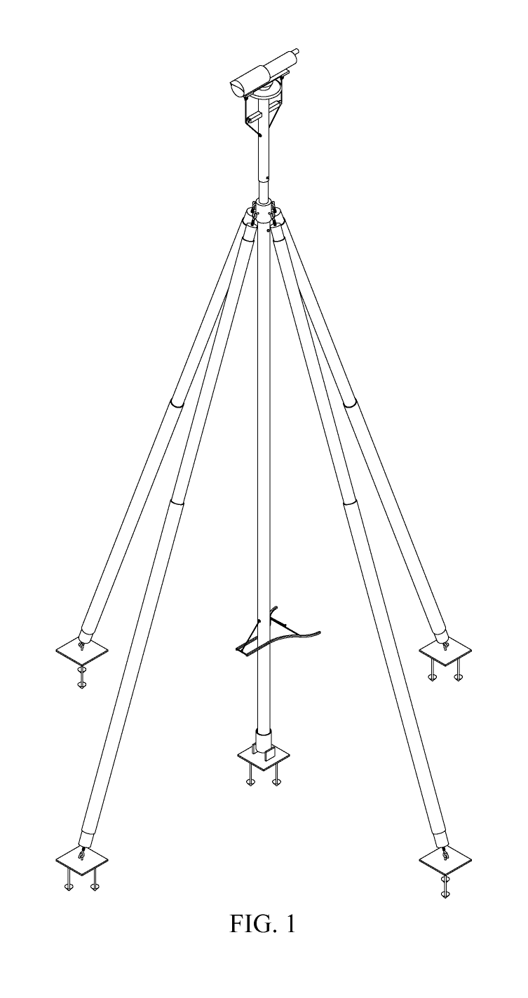

FIG. 2 is a perspective view of the present invention without the spin mast, the connector pipe, and the camera pipe.

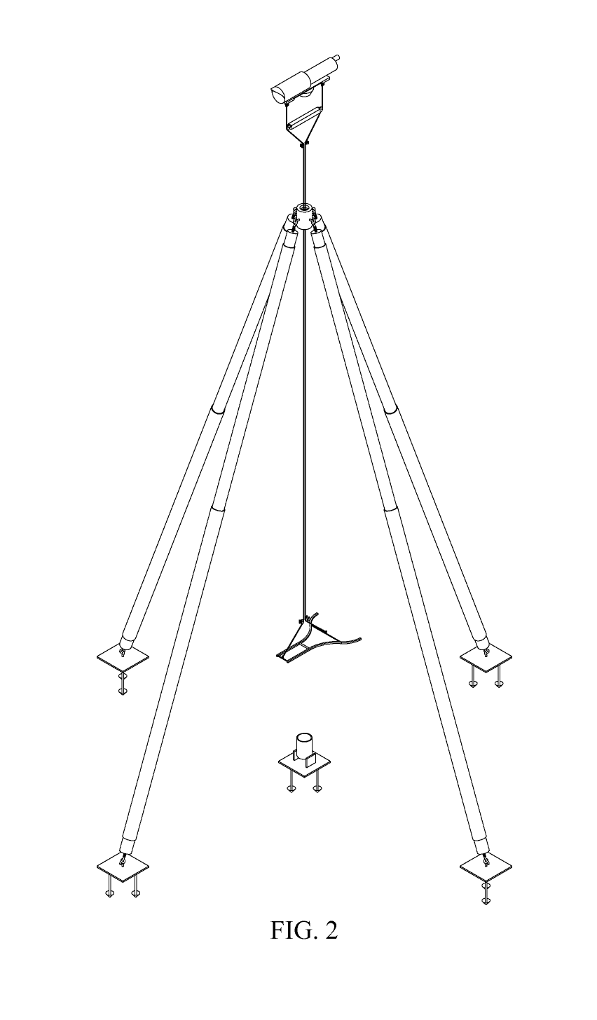

FIG. 3 is a perspective view of a turnbuckle being connected to the top sleeve and a ground plate.

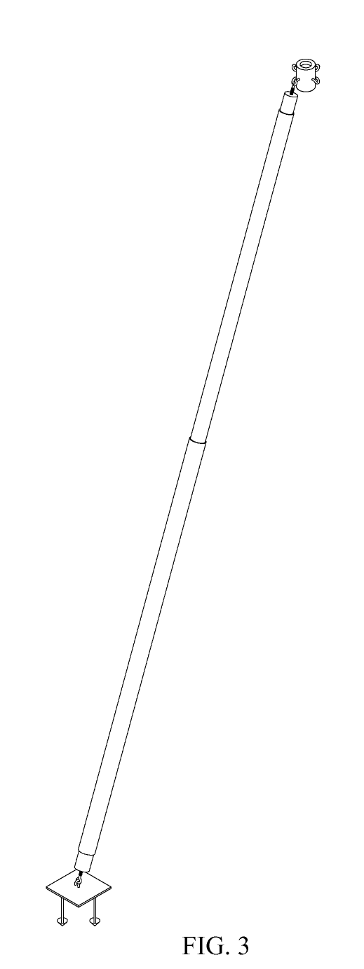

FIG. 4 is a cross-sectional view of the top of the spin mast, the top bearing, and the top sleeve.

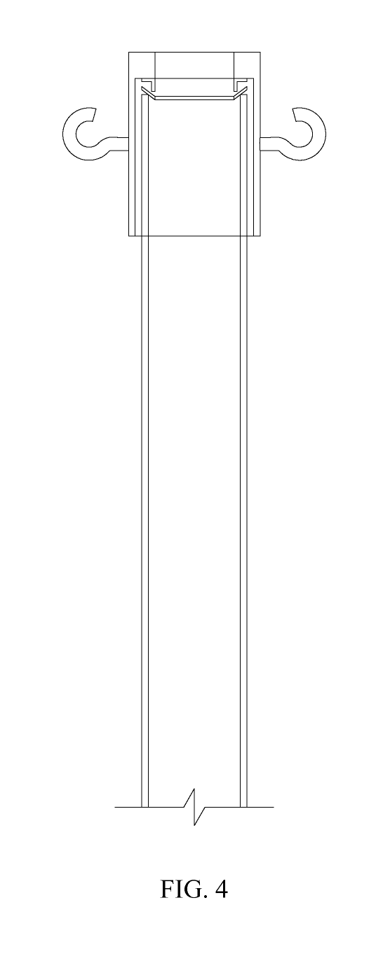

FIG. 5 is a cross-sectional view of the bottom of the spin mast, the bottom bearing, and the bottom sleeve.

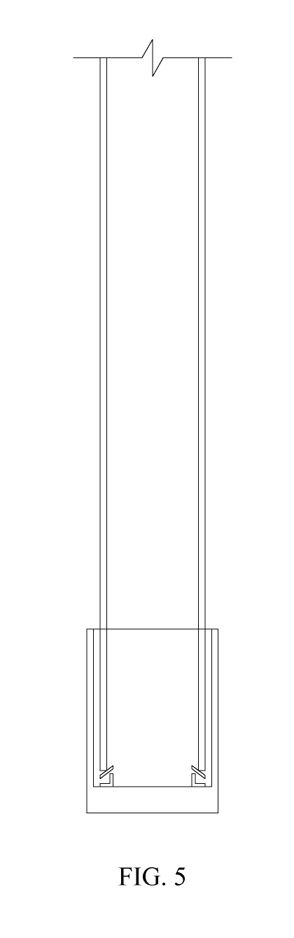

FIG. 6 is a magnified perspective view of the bottom of the present invention.

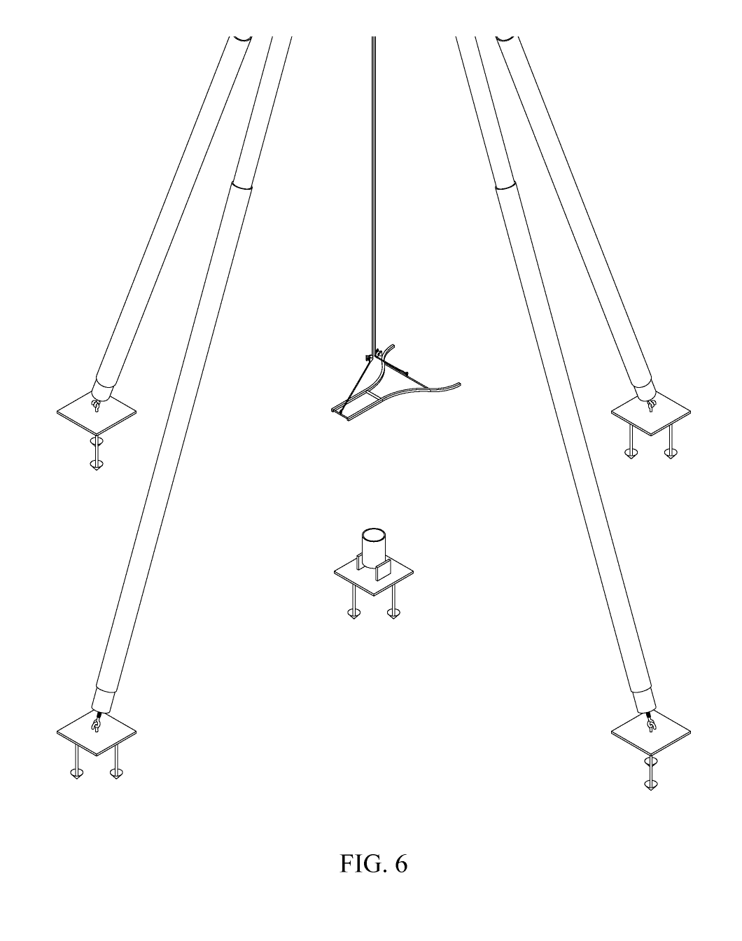

FIG. 7 is a magnified perspective view of the top of the present invention.

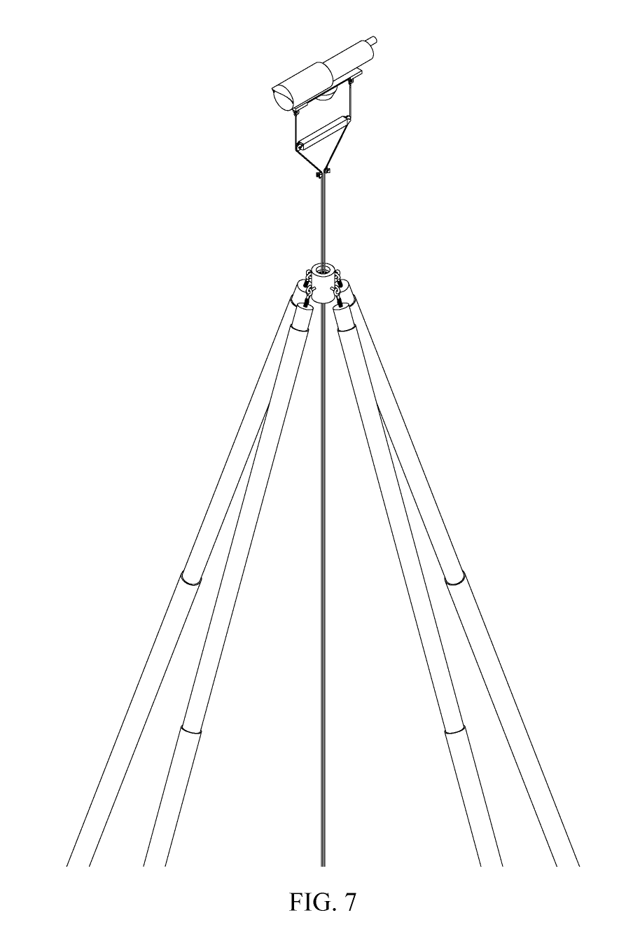

### DETAIL DESCRIPTIONS OF THE INVENTION

All illustrations of the drawings are for the purpose of describing selected versions of the present invention and are not intended to limit the scope of the present invention.

The present invention is a portable section remote camera tower, which allows the user to elevate, pan, and tilt a camera while remaining on the ground. The present invention comprises a center support 1, a plurality of turnbuckles 16, a plurality of ground plates 24, a mast plate 26, a plurality of ground anchors 29, and a camera adjustment system 30. The center support 1 is used to support the camera at a particular height off of the ground. The center support 1 is mounted on the ground with a mast plate 26. The plurality of ground plates 24 is also mounted to the ground around the mast plate 26. The center support 1 is kept plumb by attaching the plurality of turnbuckles 16 to both the top of the center support 1 and the plurality of ground plates. The camera adjustment system 30 is combination of components that are used to situate the camera atop the center support 1 and control the movement of the camera.

The center support 1 positions the camera at the proper vertical height off of the ground and bears the majority of the camera's weight. The center support 1 comprises a bottom sleeve, a top sleeve 4, a plurality of turnbuckle hooks 6, a bottom bearing 7, a top bearing 8, and a spin mast 11. The spin mast 11 is a structural tube that is positioned to be plumb and is able rotate about the center axis of the center support 1. The bottom of the spin mast 11 is inserted into the bottom sleeve, which has a closed end. The closed end 3 is located at the bottom of the bottom sleeve. The bottom bearing 7 is positioned in between closed end 3 and the bottom of the spin mast 11. Similarly, the top of the spin mast 11 is inserted into the top sleeve 4, which has an annular end. The annular end 5 is located at the top of the top sleeve 4. The top bearing 8 is positioned in between the top of the spin mast 11 and annular end. The plurality of turnbuckle hooks 6 are used to attach the top of each turnbuckle to the top of the center support 1. The plurality of turnbuckle hooks 6 is radially positioned around and connected to the top sleeve 4 so that the plurality of turnbuckles 16 evenly pull the center support from all directions, which keeps the center support 1 plumb.

The bottom bearing 7 and the top bearing 8 allow the spin mast 11 to rotate while the bottom sleeve 2 and the top sleeve 4 are held still. The bottom bearing 7 and the top bearing 8 each comprise an inner L-shaped race and outer tapered race. For bottom bearing 7, the outer tapered race 10 is located above the inner L-shaped race, which allows the bottom of the spin mast 11 to press against the outer tapered race 10 and allows the inner L-shaped race 9 to be connected to the closed end. For the top bearing 8, the outer tapered race 10 is located below the inner L-shaped race 9, which allows the top of the spin mast 11 to press against the outer tapered race 10 and allows the inner L-shaped race 9 to be connected to the annular end. The configuration of the spin mast 11, the bottom sleeve 2, the top sleeve 4, the bottom bearing 7, and the top sleeve 4 allows the outer race for both the bottom bearing 7 and the top bearing 8 to further engage the spin mast 11 as the center support 1 is compressed by the plurality of turnbuckles 16.

The mast plate 26 is a base for the center support 1 and allows the center support 1 to be positioned in one spot on the ground. The mast plate 26 has a pair of tabs 27 and a sleeve axle 28. The pair of tabs 27 are positioned to be equidistant from the center of the mast plate 26 so that the bottom sleeve 2 can fit in between the pair of tabs 27. The pair of tabs 27 are connected normal to the top of the mast plate 26. Once the closed end 3 of the bottom sleeve 2 is positioned in between the pair of tabs 27, the sleeve axle 28 traverses through both the pair of tabs 27 and the closed end, which attaches the center support 1 to the mast plate 26. The center support 1 is able to rotate about the sleeve axle 28, and the rotation of the center support 1 is guided by the pair of tabs 27. The rotation of the center support 1 becomes significant when the user is assembling the present invention. The plurality of ground plates 24 are radially positioned around the mast plate 26 on the ground and allows the plurality of turnbuckles 16 to be attached to the ground. Each of the plurality of ground plates 24 has a hook 25, which is used to attach the bottom of a turnbuckle to a ground plate. The plurality of ground anchors 29 is positioned to secure the mast plate 26 and the plurality of ground plates 24 to the ground. The plurality of ground anchors 29 is connected to the bottom of the mast plate 26 and to the bottom of each of the ground plates 24. The plurality of ground anchors 29 protrudes into the ground and firmly situates the mast plate 26 and the plurality of ground plates 24 so that the present invention can properly function.

The plurality of turnbuckles 16 are radially positioned around the center support 1 in order to provide a tension force on the center support 1 in all directions. Thus, the center support 1 is held plumb and upright because the sum of the tension forces acting on the center support 1 is zero. Each of the plurality of turnbuckles 16 comprises a telescopic leg 17, a top connector rod 20, and a bottom connector rod 21. The telescopic leg 17 is two tubes, where one tube sleeves the other tube. The telescopic leg 17 allows the user to adjust and lock the length of the turnbuckle. The telescopic leg 17 has a top female threaded block 18 and a bottom female thread block 19. The top female threaded block 18 is inserted into the top of the telescopic leg 17, which allows the inner surface of the telescopic leg 17 to be connected to the outer surface of the top female threaded block 18. Likewise, the bottom female threaded block 19 is inserted into the bottom of the telescopic leg 17, which allows the inner surface of the telescopic leg 17 to be connected to the outer surface of top female threaded block 19.

The top connector rod 20 is used to attach the top of the turnbuckle to the top sleeve, and the bottom connector rod 21 is used to attach the bottom of the turnbuckle to a ground plate. The top connector rod 20 and the bottom connector rod 21 each comprise a male threaded portion 22 and an eye portion. The male threaded portion 22 is connected adjacent to the eye portion. For the top connector rod 20, the top female threaded block 18 is engaged by the male threaded portion 22, and the eye portion 23 is linked to a turnbuckle hook 25 on the top sleeve. For the bottom connector rod 21, the bottom female threaded block 19 is engaged by the male threaded portion 22, and the eye portion 23 is engaged by the hook 25 on a ground plate.

The camera adjustment system 30 allows the user to pan and tilt the camera while the camera is elevated off the ground by the present invention. The camera adjustment system 30 comprises a maneuvering bar 31, a first cable 37, a second cable 38, a connector pipe 41, a camera pipe 42, a roller extension 47, a platform 50, a mast fastener 51, a pipe fastener 52, and a shoe 53. The camera has a camera holder, which is attached to the bottom of camera. The camera holder allows the camera to be situated on the platform. The platform 50 is connected atop the camera pipe, which is used to extend the camera away from the top sleeve. The connector pipe 41 is used to connect the camera pipe 42 to the spin mast 11 and allows the camera pipe 42 and the spin mast 11 to rotate in unison. The top of the connector rod is inserted into the bottom of the camera pipe 42 and is attached to the camera pipe 42 with the pipe fastener 52. The connector pipe 41 traverses through the annular end 5 of the top sleeve 4 and the inner L-shaped race 9 of the top bearing 8 so that the bottom of the connector rod can be inserted into the spin mast. The bottom of the of the connector rod is attached to the spin mast 11 with the mast fastener 51.

The maneuvering bar 31 allows the user rotate the spin mast 11 and, thus, rotate the camera pipe. The maneuvering bar 31 has a pair of tilt extensions 32, a tilt axle 33, a tilt-up bar 34, a tilt-down bar 34, and a pair of handles 36. The tilt axle 33 perpendicularly traverses the through the spin mast 11 and is positioned near the bottom sleeve 2 so that the maneuvering bar 31 can be accessed while the user is sitting down. The pair of tilt extensions 32 are positioned parallel to each other outside of the spin mast. Each of the pair of tilt extensions 32 are perpendicularly connected to the tilt axle 33 opposite of each other. The tilt-down bar 35 and the tilt-up bar 34 are positioned to be parallel and equidistant from the tilt axle 33. The tilt-down bar 35 is perpendicularly connected in between the pair of tilt extensions 32 adjacent to the front of the camera, and the tilt-up bar 34 is perpendicular connected in between the pair of tilt extensions 32 adjacent to the back of the camera. The pair of handle bars 36 are connected to the pair of tilt extensions 32 adjacent to the tilt-up bar 34. The pair of handle bars 36 allows the user to easily grip the maneuvering bar 31 and, thus, allows the user to rotate the spin mast 11 with relative ease.

In addition, the user can press the pair of handle bars either up or down, which rotates the tilt axle 33 on an axis that is perpendicular to rotation axis of the spin mast 11 and controls the tilt of the camera. In order to tilt the camera, the spin mast 11 needs to comprise a first mast hole, a second mast hole, a first mast roller, and a second mast roller. The first mast hole 12 and the second mast hole 13 are positioned opposite of each other and are positioned above the maneuvering bar. The first mast hole 12 is adjacent to the front of the camera, and the second mast hole 13 is adjacent to the back of the camera. The first mast roller 14 and the second mast roller 15 are connected opposite to each other on the inner surface of the spin mast. The first mast roller 14 is positioned above and adjacent to the first mast hole, and the second mast roller 15 is positioned above and the adjacent to the second mast hole.

The first cable 37 and the second cable 38 provide the tension force that is required to tilt the camera up and down. The first cable 37 and the second cable 38 each comprise a top end 39 and a bottom end. The bottom end 40 of the first cable 37 is attached to the center of the tilt-down bar. The first cable 37 then traverses through first mast hole 12 and is engaged by the first mast roller, which directs the first cable 37 to traverse through the spin mast 11 and the connector rod and to traverse into the camera pipe. Likewise, the bottom end 40 of the second cable 38 is attached to the center of the tilt-up bar. The second cable 38 then traverses through second mast hole 13 and is engaged by the second mast roller, which directs the second cable 38 to traverse through the spin mast 11 and the connector rod and to traverse into the camera pipe. The camera pipe 42 comprises a first pipe hole, a second pipe hole, a first internal roller, and a second internal roller 46. The first internal roller 45 and the second internal roller 46 are diametrically opposed to each other on the inner surface of the camera pipe. The first pipe hole 43 and the second pipe hole 44 are positioned above the first internal roller 45 and the second internal roller 46. The first cable 37 is engaged by the first internal roller 45 and traverses out of the camera pipe 42 through the first pipe hole. Similarly, the second cable 38 is engaged by the second internal roller 46 and traverses out of the camera pipe 42 through the second pipe hole.

The other components of the camera adjustment system 30 that are used to tilt the camera are the roller extension 47 and the shoe. The roller extension 47 traverses through the camera pipe 42 below the platform 50 and above the first pipe hole 43 and the second pipe hole. The roller extension 47 is positioned perpendicular both to the rotation axis of the spin mast 11 and the rotation axis of the tilt axle. The roller extension 47 comprises a first extension roller 48 and a second extension roller. The first extension roller 48 is positioned at one end of the roller extension 47 adjacent to the first pipe hole 43 and the first internal roller. Likewise, the second extension roller 49 is positioned at the other end of the extension roller adjacent to the second pipe hole 44 and the second internal roller 46. The shoe 53 is positioned in between the camera and the camera holder along the length of the camera and is aligned to be parallel with the roller extension. The shoe 53 allows the camera adjustment system 30 to brace the camera. The shoe 53 comprises a first cable eye 54 and a second cable eye. The first cable eye 54 and the second cable eye 55 protruded out of the shoe 53 opposite to the camera. The first cable eye 54 is positioned adjacent and above the first extension roller, and the second cable eye 55 is positioned adjacent and above the second extension roller. After the first cable 37 traverses through the first pipe hole, the first cable 37 is engaged by the first extension roller, and the top end 39 of the first cable 37 is attached to the first cable eye. Similarly, the second cable 38 is engaged by the second extension roller, and the top end 39 of the second cable 38 is attached to the second cable eye 55 after the second cable 38 traverses through the second pipe hole.

The arrangement of the cable and the corresponding components allow the user to tilt the camera up and down. The user can push down on the pair of handle bars in order to pull down the second cable, which tilts the camera upwards. The user can also pull up the pair of handle bars in order to pull down the first cable, which tilts the camera downwards.

The lifting mechanism is used to assembly the present invention. The lifting mechanism comprises a lift bar (Johnson bar), a winch cable, a pulley, and a winch. In order to assemble the present invention, the mast plate 26 is anchored into the ground, and the plurality of ground plates 24 are radially positioned and anchored around the mast plate. The one end of the lift bar is then attached to the bottom sleeve 2 and is positioned normal to the ground while the center support 1 lies on the ground. The other end of the lift bar is attached to the bottom of one of the turnbuckles and is also attached to the winch cable. Next, the winch uses the pulley and the winch cable to pull the lift bar towards the ground, which rotates the center support 1 on the sleeve axle 28 and moves the center support 1 upwards. Once the center support 1 is upright, the rest of the turnbuckles are attached to the other ground plates so the center support 1 remains perfectly plumb.

In another embodiment, the present invention does not have camera adjustment system 30 and is simply used as a stand to elevated a piece of equipment off of the ground. In addition, the present invention in this embodiment does not allow the spin mast 11 to rotate, which eliminates the need for a bottom bearing 7 and a top bearing 8 within the center support 1. This embodiment allows the bottom of the spin mast 11 to directly connect to the bottom sleeve 2 and allows the top of the spin mast 11 to directly connect to the top sleeve.

In another embodiment, the present invention uses only three turnbuckles, which allows a camera to attached to the spin mast 11 on a shelf. The camera in this embodiment would have a sixty degree field of vision, which is better field of vision than if the camera was attached to the spin mast 11 with four or more turnbuckles. If the shelf is hinged on the spin mast, then the camera can be tilted by a rod that is jointly connecting the front of the maneuvering bar 31 to the bottom of the shelf.

Although the invention has been explained in relation to its preferred embodiment, it is to be understood that many other possible modifications and variations can be made without departing from the spirit and scope of the invention as hereinafter claimed.

What is claimed is:

1. A portable section remote camera tower comprises,
a center support;
said center support comprises a bottom sleeve, a top sleeve, a plurality of turnbuckle hooks, a bottom bearing, a top bearing, and a spin mast;
said bottom sleeve comprises a closed end;
said top sleeve comprises an annular end;
said bottom bearing and said top bearing each comprise an inner L-shaped race and an outer tapered race;
said spin mast comprises a first mast hole, a second mast hole, a first mast roller, a second mast roller;
a plurality of turnbuckles;
each of said plurality of turnbuckles comprises a telescopic leg, a top connector rod, and a bottom connector rod;
said telescopic leg comprises a top female threaded block and a bottom female threaded block;
said top connector rod and said bottom connector rod each comprise a male threaded portion and a eye portion;
a plurality of ground plates;
each of said plurality of ground plates comprises a hook;
a mast plate;
said mast plate comprises a pair of tabs and a sleeve axle;
a plurality of ground anchors;
a camera adjustment system;
said camera adjustment system comprises a maneuvering bar, a first cable, a second cable, a connector pipe, a platform, a camera pipe, a roller extension, a mast fastener, a pipe fastener, and a shoe;
said maneuvering bar comprises a pair of tilt extensions, a tilt axle, a tilt-up bar, a tilt-down bar, and a pair of handles;
said first cable and said second cable each comprise a top end and a bottom end;
said camera pipe comprises a first pipe hole, a second pipe hole, a first internal roller, and a second internal roller; and
said roller extension comprises a first extension roller and a second extension roller.

2. The portable section remote camera tower as claimed in claim 1 comprises,
said plurality of ground plates being radially positioned around said mast plate;
said center support being located above said mast plate;
said plurality of turnbuckles being radially positioned around said center support; and
each of said plurality of turnbuckles being aligned to said plurality of ground plates.

3. The portable section remote camera tower as claimed in claim 2 comprises,
said pair of tabs being centrally positioned above said mast plate;
said pair of tabs being connected normal to said mast plate;
said hook of each of said plurality of ground plates being centrally connected above to each of said plurality of ground plates; and
said plurality of ground anchors being connected below to said plurality of ground plates and to said mast plate.

4. The portable section remote camera tower as claimed in claim 1 comprises,
said bottom sleeve being positioned below said spin mast;
said closed end being connected below to said bottom sleeve;
said spin mast being inserted into said bottom sleeve;
said bottom bearing being positioned within said bottom sleeve in between said closed end and said spin mast;
said closed end being positioned in between said pair of tabs; and
said closed end and said pair tabs being traversed through by said sleeve axle.

5. The portable section remote camera tower as claimed in claim 4 comprises,
said inner L-shaped race of said bottom bearing being located below said outer tapered race of said bottom bearing;
said spin mast being pressed against said outer tapered race of said bottom bearing; and
said closed end being connected below to said inner L-shaped race.

6. The portable section remote camera tower as claimed in claim 1 comprises,
said top sleeve being positioned atop said spin mast;
said annular end being connected atop said top sleeve;
said spin mast being inserted into said top sleeve;
said top bearing being positioned within said top sleeve in between said spin mast and said annular end;
said plurality of turnbuckle hooks being radially positioned around said top sleeve; and
said plurality of turnbuckle hooks being connected to said top sleeve.

7. The portable section remote camera tower as claimed in claim 6 comprises,
said inner L-shaped race of said top bearing being located above said outer tapered race of said top bearing;
said spin mast being pressed against said outer tapered race of said top bearing; and
said annular end being connected to said inner L-shaped race.

8. The portable section remote camera tower as claimed in claim 1 comprises,
said top female threaded block traversing into said telescopic leg;
said top female threaded block being connected to said telescopic leg;
said top female threaded portion being engaged by said male threaded portion of said top rod connector;
said eye portion of said top rod connector for each of said plurality of turnbuckles being linked to said plurality of turnbuckle hooks;
said bottom female threaded block traversing into said telescopic leg opposite to said top female threaded block;
said bottom female threaded block being connected to said telescopic leg;
said bottom female threaded block being engaged by said male threaded portion of said bottom connector rod; and
said eye portion of said bottom connector rod for each of said plurality of turnbuckles being engaged by said hook for each of said plurality of ground plates.

9. The portable section remote camera tower as claimed in claim 1 comprises,
said connector pipe concentrically traversing into said spin mast through said annular end and through said inner L-shaped race of said top bearing;
said connector pipe being attached to said spin mast by said mast fastener below said top sleeve;
said camera pipe being positioned above said top sleeve;
said connector pipe traversing into said camera pipe;
said connector pipe being attached to said camera pipe by said pipe fastener;
said platform being connected atop said camera pipe;
said roller extension perpendicularly traversing through said connector pipe; and
said shoe being located above said platform and being aligned with said roller extension.

10. The portable section remote camera tower as claimed in claim 9 comprises,
said first extension roller being attached adjacent to said roller extension;
said second extension roller being attached adjacent to said roller extension opposite to said first extension roller;
said first cable eye being connected to said shoe adjacent to said first extension roller;
said second cable eye being connected to said shoe adjacent to said second extension roller;
said first internal roller being attached within said camera pipe adjacent and below to said first extension roller;
said second internal roller being attached within said camera pipe adjacent and below to said first extension roller;
said first pipe hole being positioned on said camera pipe in between said roller extension and said first internal roller;
said second pipe hole being positioned on said camera pipe in between said roller extension and said second internal roller;
said tilt axle being positioned perpendicular to said roller extension;
said tilt axle perpendicularly traversing through said spin mast adjacent to said bottom sleeve;
said pair of tilt extensions being positioned opposite of each other along said tilt axle;
said pair of tilt extensions being perpendicularly connected to said tilt axle outside of said spin mast;
said tilt-up bar and said tilt-down bar being positioned equidistant from said tilt axle;
said tilt-down bar being perpendicularly connected in between to said pair of tilt extensions adjacent to said first pipe hole;
said tilt-up bar being perpendicularly connected in between to said pair of tilt extensions adjacent to said second pipe hole;
each of said pair of handles being connected to said pair of tilt extensions adjacent to said tilt-up bar;
said first mast hole and said second mast hole being positioned opposite to each other on said spin pipe above said tilt axle;
said first mast hole being positioned adjacent to said tilt-down bar; and
said second mast hole being positioned adjacent to said tilt-up bar.

11. The portable section remote camera tower as claimed in claim 10 comprises,
said bottom end of said first cable being centrally attached to said tilt-down bar;
said first cable traversing into said spin mast through said first mast hole;
said first cable traversing through said spin mast and said connector pipe and traversing into said camera pipe;
said first cable being engaged by said first mast roller and by said first internal roller;
said first cable traversing out of said camera pipe through said first pipe hole;
said first cable being engaged by said first external roller;
said top end of said first cable being attached to said first cable eye;
said bottom end of said second cable being centrally attached to said tilt-down bar;
said second cable traversing into said spin mast through said second mast hole;
said second cable traversing through said spin mast and said connector pipe and traversing into said camera pipe;
said second cable being engaged by said second mast roller and by said second internal roller;
said second cable traversing out of said camera pipe through said second pipe hole;
said second cable being engaged by said second external roller; and
said top end of said second cable being attached to said second cable eye.
